(19) United States
(12) Patent Application Publication
(10) Pub. No.: US 2022/0411169 A1
(43) Pub. Date: Dec. 29, 2022

(54) PISTON FOR A COLLAPSIBLE CARTRIDGE

(71) Applicant: Sulzer Mixpac AG, Haag (CH)

(72) Inventors: Hayden TURNER, Ayer, MA (US); Evan TRAVERS, Groveland, MA (US)

(21) Appl. No.: 17/730,686

(22) Filed: Apr. 27, 2022

Related U.S. Application Data
(63) Continuation of application No. 16/956,821, filed on Jun. 22, 2020, now Pat. No. 11,414,260.
Application No. 16/956,821 is a continuation of application No. 15/855,357, filed on Dec. 27, 2017, now Pat. No. 10,968,031.

(51) Int. Cl. B65D 83/00; B05C 17/005; B05C 17/015

(52) U.S. Cl. CPC B65D 83/0005; B05C 17/00553; B05C 17/015; B05C 17/00583; B05C 17/00579; B65D 83/005; B65D 83/0072; B65D 81/325

(57) ABSTRACT

A piston for a collapsible cartridge for dispensing a material, the piston includes a rigid portion and a flexible portion. The rigid portion has a first diameter, a first end and a second end. The first end is configured to be disposed in a material dispensing direction. The flexible portion has a second diameter less than the first diameter, a first end disposed in the material dispensing direction and a second end disposed in an opposite direction. The flexible portion is disposed on the first end of the rigid portion such that the second end of the flexible portion is disposed to face the first end of the rigid portion. The flexible portion is configured to radially expand and longitudinally compress upon a force applied to the first end of the flexible portion to compress the collapsible cartridge between the flexible portion and an interior surface of a support cartridge.

### CROSS REFERENCE TO RELATED APPLICATION

This application is a divisional of U.S. application Ser. No. 16/956,821, filed Jun. 22, 2020, which is a U.S. National Stage application of International Application No. PCT/EP2018/086391, filed Dec. 20, 2018, which claims priority to U.S. patent application Ser. No. 15/855,357, filed Dec. 27, 2017, now U.S. Pat. No. 10,968,031, issued Apr. 6, 2021, the contents of each of which are incorporated herein by reference.

### BACKGROUND

### Field of the Invention

The invention relates to piston for a collapsible cartridge. In particular, the invention relates to piston for a collapsible cartridge that reduces waste and air volume in the cartridge.

### Background of the Invention

In the construction and dental sectors, cartridges are frequently used to dispense liquids, for example, sealing components, components for chemical dowels or chemical anchors, adhesives, pastes or impression materials in the dental sector.

Conventional dispensers can be single-component systems in which the material to be dispensed is formed from one component and two-component or multicomponent systems in which at least two different components are stored in separate chambers of the same cartridge or in separate cartridges. The two-component or multicomponent systems, the components are mixed by a dynamic or static mixing apparatus. Examples of multicomponent systems include adhesives or chemical dowels which only harden after the mixing of the two components. Two-component systems can also be used in the industrial sector for paints which are often used to generate functional protective layers such as for corrosion protection.

Many conventional systems can include prefilled cartridges designed for a single use. In such systems a substantial amount of waste results both with regard to volume and to mass. An alternative to these cartridges are unfilled cartridges that can be transported by the cartridge manufacturers to the manufacturers of the filling materials who then fill the empty cartridges. Even though the unfilled cartridges have a relatively low weight, the costs for the transport of the empty cartridges from the cartridge manufacturers to the media manufacturers are relatively high since the empty cartridges have a relatively large volume and thus high space requirements on transport. The storage costs for the empty cartridges both at the cartridge manufacturers' and at the media manufacturers' are furthermore also relatively high due to the space requirements. These costs make up a not insubstantial portion of the total manufacturing costs of the cartridges.

### SUMMARY

It has been discovered that providing a system and method to improve the collapsing of the cartridge would be advantageous. In particular, it has been determined that an improvement in collapsing the cartridge can reduce the space need for storing and shipping purposes and reduces the waste of a component filing the cartridges.

In view of the state of the known technology, one aspect of the present disclosure is to provide a piston for a collapsible cartridge for dispensing a material, the piston comprising a rigid portion and a flexible portion. The rigid portion has a first diameter, a first end and a second end. The first end is configured to be disposed in a material dispensing direction. The flexible portion has a second diameter less than the first diameter, a first end disposed in the material dispensing direction and a second end disposed in an opposite direction. The flexible portion is disposed on the first end of the rigid portion such that the second end of the flexible portion is disposed to face the first end of the rigid portion. The flexible portion is configured to radially expand and longitudinally compress upon a force applied to the first end of the flexible portion so as to compress the collapsible cartridge between the flexible portion and an interior surface of a support cartridge.

Another aspect of the present disclosure is to provide a dispensing system, comprising a cartridge and a piston. The cartridge has a head part and a cartridge wall which define a reception chamber configured to retain a medium to be dispensed. The head part includes a surface and an outlet in the surface. The outlet is configured to enable the material to be dispensed therethrough. The cartridge wall is configured to be collapsible. The piston is configured to collapse the cartridge and dispense the medium. The piston includes a rigid portion having a first diameter, a first end and a second end, the first end configured to be disposed in a material dispensing direction, and a flexible portion having a second diameter less than the first diameter, a first end disposed in the material dispensing direction and the second end disposed in an opposite direction. The flexible portion is disposed on the first end of the rigid portion such that the second end of the flexible portion is disposed to face the first end of the rigid portion, and the flexible portion is configured to radially expand between about 1 mm and 3 mm upon a force being applied to the piston in the material dispensing direction such that the first end of the flexible portion contacts the surface of the head part.

Another aspect of the present disclosure is to provide a method of filling a material into a cartridge, the method comprising collapsing the cartridge with a piston, the piston having a rigid portion and a flexible portion, the flexible portion being disposed at the dispensing end of the piston, applying a force to the piston such that the flexible portion of the piston contacts a surface of a head part of the cartridge, causing a diameter of the flexible portion to radially increase, compressing the cartridge between a radial surface of the flexible portion and am interior surface a cartridge support, and adding the material through an opening in the head part, causing the piston to move in a direction away from the head part.

### BRIEF DESCRIPTION OF THE DRAWINGS

Referring now to the attached drawings which form a part of this original disclosure:

FIG. 1 illustrates an exploded perspective view of a piston according to a first embodiment of the present invention in combination with a support cartridge;

FIG. 2 is an exploded side elevational view of the support cartridge of FIG. 1;

FIG. 3 is a side view of two-component cartridge of FIG. 1 is an expanded state;

FIG. 4 is a side view of the two-component cartridge of FIG. 1 is a compressed state;

FIG. 5 illustrates a partial side elevational view of the piston of FIG. 1;

FIG. 6 is a top perspective view of the piston of FIG. 5 with the flexible portion removed;

FIG. 7A-7E illustrate the filling process for the cartridge of FIG. 1;

FIG. 8 illustrates a partial cross-section view of the piston and cartridge of FIG. 1 in a compressed state; and

FIG. 9 illustrates a partial cross section view of a second embodiment of a piston.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

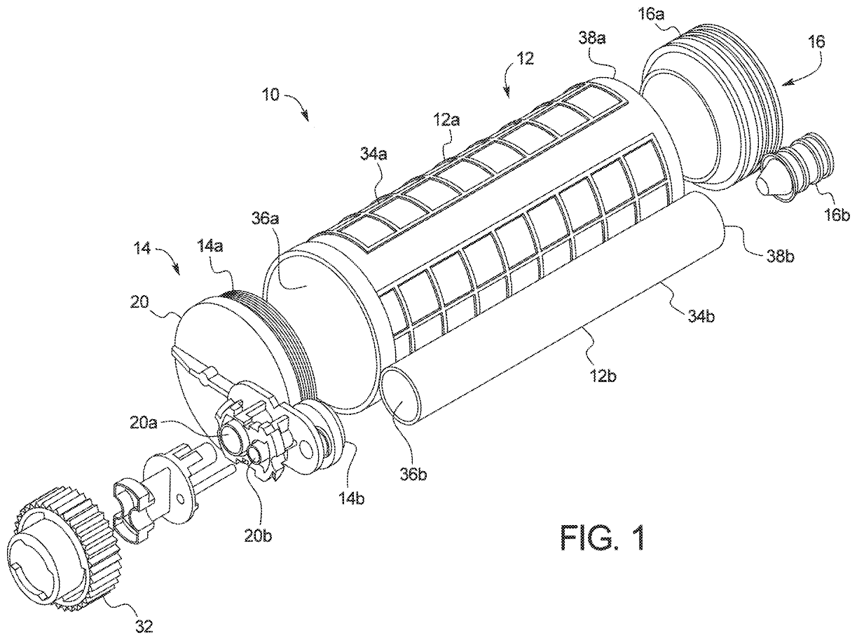

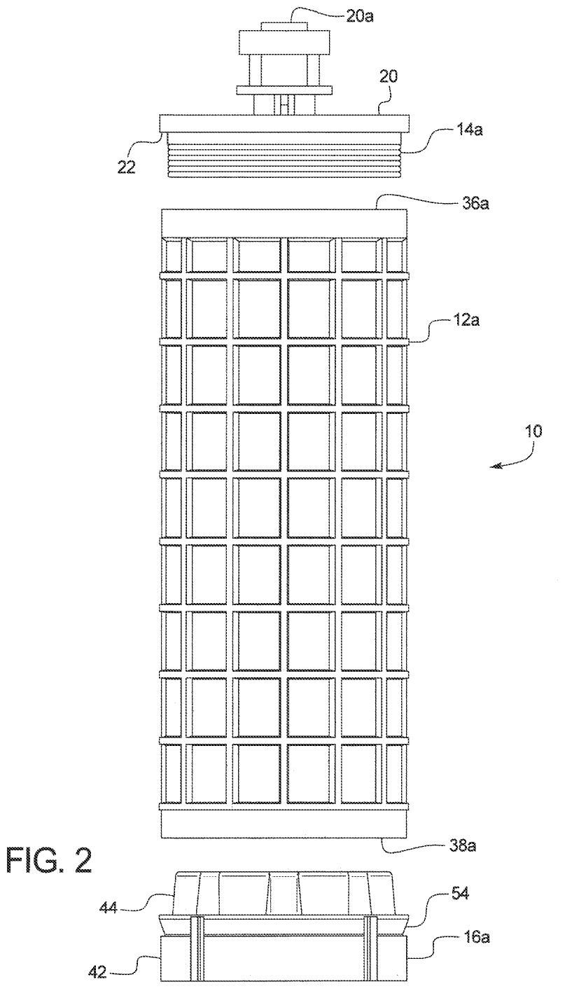

Referring initially to FIGS. 1 and 2, a dispensing system 10 according to an embodiment of the present invention is illustrated. The dispensing system 10 includes a support cartridge system 12, a two-component collapsible cartridge 14 and piston system 16. As can be understood, the dispensing system 10, when filled with a component, can be inserted into a dispensing device to dispense the component or components, as is known in the art.

As is understood, a dispensing system 10 for two-components, as described herein, is configured to hold, store and dispense two separate components. The two components can be mixed upon dispensing or at any suitable time. Such a two-component dispensing system enables materials or components that would otherwise be stored for a significant time period to be stored and used at a later time. It is noted that the piston and dispensing system 10 described herein can be used in a single component dispensing system, a two-component dispensing system or a multicomponent (more than two) system, if desired.

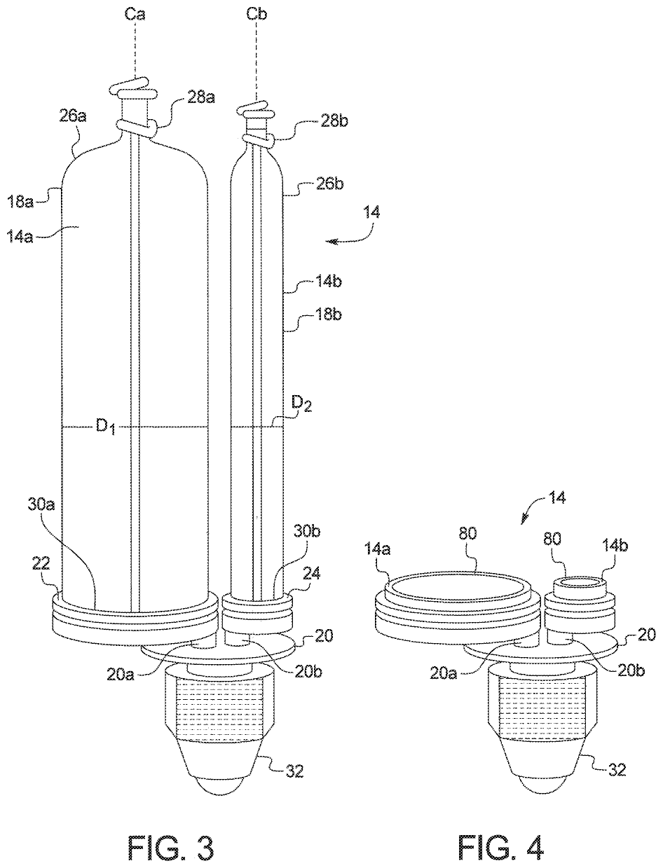

Turning to FIG. 3, a two-component collapsible cartridge 14 is illustrated. The cartridge includes a first generally cylindrical reception chamber (or cartridge) 14a and a second generally cylindrical reception chamber (or cartridge) 14b. The reception chambers 14a and 14b are each defined by a cartridge wall 18a and 18b and a common head part 20. The common head part 20 preferably forms an end-face or surface 22 and 24 of each of the reception chambers 14a and 14b. The ends 26a and 26b of the two cartridge walls 18a and 18b are disposed remote from the head part 20 and are each led together toward the center axis Cₐ and C_{b} of the respective reception chamber 18a and 18b and can be bound together by a respective clamping ring 28a and 28b, or in any other suitable manner, such that the ends are capable of being sealingly closed.

As shown in FIG. 3, the first reception chamber 14a has a diameter D₁ that is larger than the diameter D₂ of the second reception chamber 14b; however, the reception chambers 14a and 14b can have the same or substantially the same diameter, or have any diameter desired. That is, the diameters can have any relative size to each other that would enable two separate components or materials to be mixed together in a suitable or desired ratio.

The ends 30a and 30b of the reception chambers 14a and 14b facing the head part 20 are sealingly and unreleasably connected to the head part 20. In one embodiment, the head part 20 is injection molded to the ends of the reception chambers 14a and 14b. The head part 20 can be formed from a stable-shape plastic, and the cartridge walls 18a and 18b can be formed as multilayer films which are each rolled to a cylindrical shape in their predominantly center regions and are welded or otherwise connected to form a seam 31 at their longitudinal edges thus forming together with the head part 20 the cylindrical reception chambers 18a and 18b.

The head part 20 preferably includes two outlets 20a and 20b which are connected to the reception chambers 18a and 18b for filling the reception chambers with a filling component or material and for dispensing the filling component or material out of the reception chambers. A screw cap 32 can be used to close the outlets.

As can be understood, FIG. 3 illustrates the reception chambers 14a and 14b in an empty state. In other words, the reception chambers 14a and 14b, as shown in FIG. 3 have not yet filled with a component, i.e. with the material to be dispensed. However, as shown in this embodiment, the cartridge walls 18a and 18b have a substantially cylindrical shape due to the stiffness of the used film material. It is noted that this cylindrical shape represents the expanded state of the reception chambers 14a and 14b with a maximum volume of the reception chambers.

As shown in FIG. 4, the cartridge walls 18a and 18b can pushed together or compressed in the longitudinal direction of the reception chambers 14a and 14b before filling with the component. When the collapsed state is accomplished as described herein, this state has been determined to reduce the space need for storing and shipping purposes and reduces the waste of a component filing the reception chambers 14a and 14b.

Turning back to FIGS. 1 and 2, the support cartridge system 12, includes first and second support cartridges 12a and 12b that include first and second hollow cylinders 34a and 34b, respectively. The first and second hollow cylinders 34a and 34b are sized and configured to receive the first and second reception chambers 14a and 14b and of the two-component collapsible cartridge 14, respectively. The first and second hollow cylinders 34a and 34b each have a first opening 36a and 36b and a second opening 38a and 38b. The first openings 36a and 36b are configured to receive a respective reception chamber 14a and 14b and the second opposite openings 38a and 38b are configured to receive a respective piston 16a and 16b. As will be described herein, the first and second reception chambers 14a and 14b and can be pushed into a respective reception opening 36a and 36b until the head part 20 contacts the end of the respective support cartridge 12a and 12b.

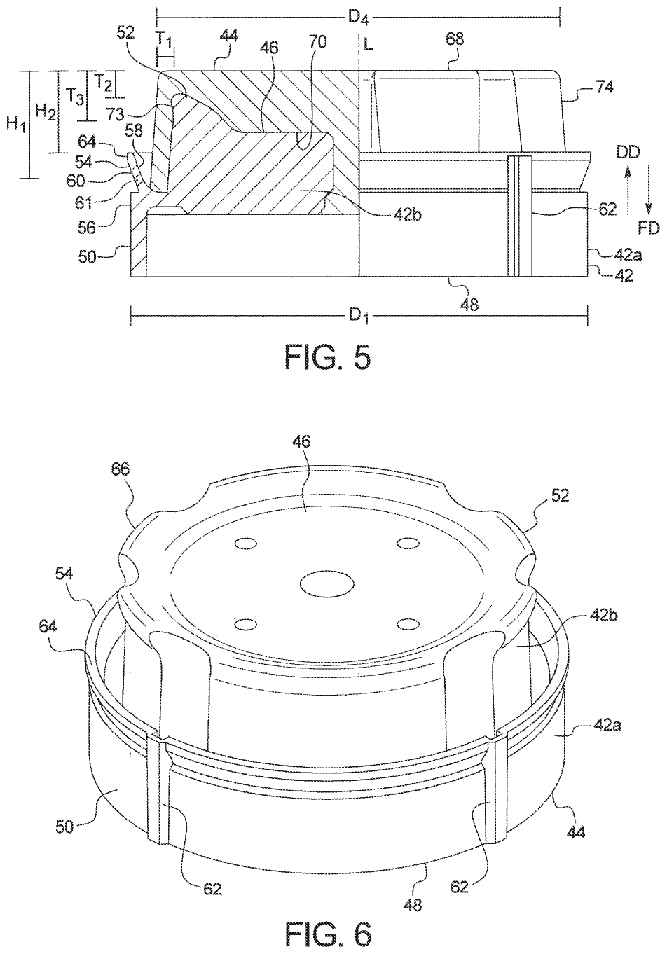

The piston system 16 includes first and second pistons 16a and 16b, which generally have the same configuration, with the main difference being size or relative diameter. Thus, only the first piston 16a will be described in detail in view of FIGS. 5 and 6. FIGS. 5 and 6 illustrate a first embodiment of the present invention. The piston 16a is preferably generally cylindrical, and sized and configured to tightly fit within the inner peripheral surface 40 of the support cartridge 12a. It is noted that in this embodiment, the piston 16a does not need to form a seal with the support cartridge 12a. However, the piston 16a preferably forms a tight fit with the support cartridge 12a to prevent the reception chamber 14a from being pinched between the support cartridge 12a and the piston 16a.

The piston 16a has a first portion 42 and a second portion 44. Preferably, the first portion 42 is a rigid portion having a first diameter D₃, a first end 46 and a second end 48. The first end 46 of the rigid portion is disposed in the material dispensing direction DD (i.e., the direction in which the component is dispensed), and the second end 48 is disposed in the opposite direction (filling direction FD). The second end 48 of the rigid portion 42 can receive the pressure or force that is required to move the piston through the support cartridge 12a. The rigid portion 42 is preferably formed from any suitable plastic or metal that is rigid and does not flex under pressure. However, the rigid portion 42 can be formed from any suitable material.

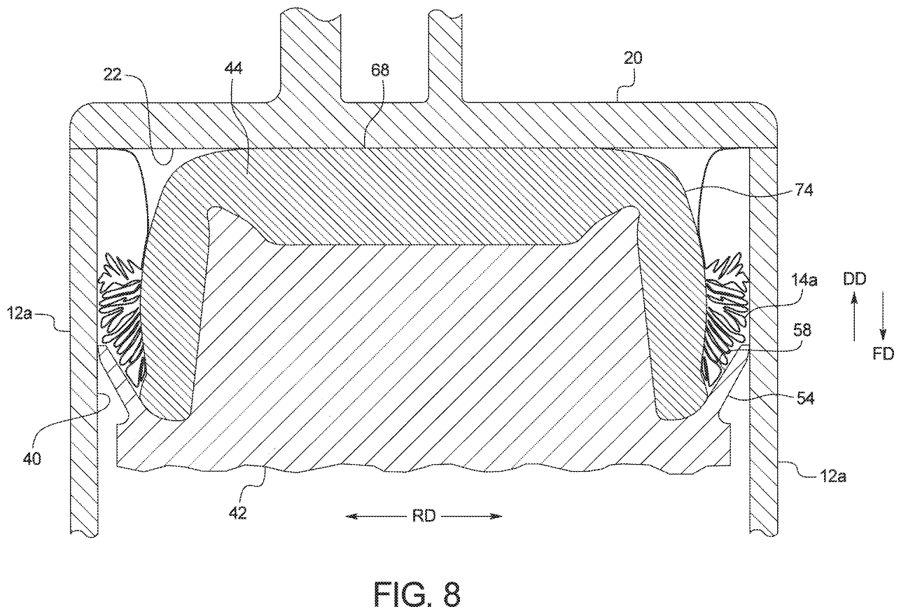

As shown in FIG. 6, the rigid portion 42 includes a first rigid portion 42a and a second rigid portion 42b. The first rigid portion 42a is disposed externally of the second portion 44, and the second rigid portion 42b is disposed within the second portion 44. The first rigid portion 42a includes a radial outer surface 50 adjacent the second end 48 and the second rigid portion 42b includes a protrusion 52 adjacent the first end 46. The radial outer surface 50 includes a skirt 54 or sealing lip extending therefrom in the dispensing direction. The skirt 54 preferably extends around the entire circumference of the first rigid portion 42a, but can extend in any suitable or desired manner. The skirt 54 preferably extends radially outwardly from the end 56 of the radial outer surface 50 and has a diameter about the same size as the inner diameter of the support cartridge 12a. Accordingly, the skirt 54 is sized and configured to slide within the inner surface of the support cartridge 12a. In this connection, it should be noted that the skirt 54 is configured to fit within the support cartridge 12a in such a way that it does not tilt relative to the dispensing direction DD but also does not seal against the inner surface so that the piston 16a can move within the support cartridge 12a. In one embodiment, a hole 61 or a plurality of holes can be disposed in the skirt 54 or the rigid body 42 to enable air to pass in a direction opposite to the dispensing direction DD during dispensing. It is to be understood that the hole 61 may also be used to allow air to pass in the dispensing direction DD during filling of the respective reception chambers 14a and 14b, i.e. the air is allowed to pass in a direction opposite to the filling direction FD. Such a structure prevents air from being trapped between the piston 16a and the reception chamber 14a, while allowing a tight fit between the skirt 54 and the inner peripheral surface 40 of the support cartridge 12a. Moreover, the skirt 54 preferably extends in the material dispensing direction so to be capable of fitting a portion of or the entire cartridge wall 18a (in the collapsed state) between an inner surface 58 thereof and the second portion 42 (See FIG. 8).

In one embodiment, the radial outer surface 50 of the first rigid portion 42a and the outer surface 60 of the skirt 54 also includes a plurality of integrated ribs or tabs 62 spaced radial therearound. The tabs 62 generally protrude from the radial outer surface 50 of the rigid portion 42 and the outer surface 60 of the skirt 54 and extend in a longitudinal direction of the dispensing direction DD. In one embodiment, the radial outer surface 50 and the outer surface 60 of the skirt 54 includes four tabs 62 evenly spaced therearound; however, it is noted that there can be any suitable number of tabs 62, and the tabs 62 can be spaced in any suitable manner. As shown in FIG. 6, the tabs 62 can be rectangular in shape and can extend from the second end 48 of the rigid portion 42 to the end 64 of the skirt 54. The tabs 62 prevent the cartridge wall 18a, when being compressed, to pass over the end 64 of the skirt 54 of the piston 16a. When the cartridge wall 18a passes over the end 64 of the skirt 54, portions of the cartridge wall 18a can be pinched and broken between the piston 16a and the support cartridge 12a. If the cartridge wall 18a is compromised in this manner, a new flow path for the component or material can be formed, creating an undesirable ballooning effect behind the piston 16a.

The protrusion 52 is preferably cylindrical and has a diameter that is less than the diameter of the end 64 of the skirt 54. The protrusion 52 can include an arcuate edge 66 that extends from the edge formed by the first end 46 and the upper radial surface 68 of the second rigid portion 42b. This protrusion 52 increases the support at the edge 66 and guides the cartridge wall 18a to allow the cartridge wall 18a to fit the piston geometry, furthering the amount of material to be dispensed out of the two-component collapsible cartridge 14.

As illustrated in FIG. 5, the second portion 44 preferably is a flexible portion having a second diameter D₄ that is less than the diameter D₃ of the first rigid portion 42a, a first end 68 disposed in the material dispensing direction DD and a second end 70 disposed in the opposite direction (filling direction FD). The flexible portion 44 is disposed on the first end 46 of the rigid portion 42 such that the second end 70 of the flexible portion 44 is disposed to face the first end 46 of the rigid portion 42.

The flexible portion 44 is preferably formed from a material that is capable of radially expanding and longitudinally compressing upon a force applied to the first end 68 of the flexible portion 44 so as to compress the collapsible cartridge between the flexible portion 44 and the surface 22 of the support cartridge 12a. Thus, the flexible portion 44 can be formed any material suitable to accomplish sufficient radial expansion. Suitable materials can include, but are not limited to thermoplastic elastomer (TPE), silicone, any other elastomeric material or any suitable flexible material. In one embodiment, the flexible portion 44 is formed from a material having a durometer between about 15 and 60 on the durometer A scale. Preferably, the flexible material is formed from a material having a durometer around 25 shore A.

The flexible portion 44 includes an internal cavity 72 and at least a portion of the rigid portion 42 extends into the internal cavity 72. In other words, the flexible portion 44 has a recessed portion that defines an integral cavity 72 that is sized and configured to receive the rigid portion 42. As described above, this embodiment increases the support at the edge and guides the cartridge wall 18a to allow the cartridge wall 18a to fit the piston geometry, furthering the amount of material to be dispensed out of the two-component collapsible cartridge 14.

The overall height of the flexible portion 44 relative to the cartridge wall 18a length should be determined such that the flexible portion 44 makes initial contact with the end surface 22 of the head part 20 about 1-2 mm prior to the cartridge wall 18a reaching its compressed height. Such a compression distance will generally result in sufficient radially expansion to compress the cartridge wall 18a. However, the deflection of the flexible portion 44 close to the edges is reduced due to the protrusion 52 as discussed above, otherwise the tension of the cartridge wall 18a in this area may cause a larger than desired diameter. Such an increased diameter can trap material and air on the inside of the cartridge wall 18a which is undesirable.

As can be seen best from the cross sectional view of FIG. 5, the cavity 72 of the flexible portion 44 forms a recess 71 that receives the protrusion 52 of the rigid portion 42. Preferably, the protrusion 52 is received in the recess 71 in a form fit manner. Receiving the protrusion 52 in the recess 71 allows for a secure seating of the flexible portion 44 on the rigid portion 42. Furthermore, on compression of the flexible portion 44 in the dispensing direction DD, the protrusion 52 received in the recess 71 prevents that the flexible portion 44 excessively expands in the radial direction. Simultaneously, the flexible portion 44 is directed into the dispensing direction DD and exerts a force on the cartridge 14 so that more material is dispensed therefrom.

As the flexible portion 44 is compressed against the end surface 22 of the head part 20, the flexible material or the flexible portion 44 is longitudinally compressed and radially expanded. In other words, the flexible portion 44 can be flattened against the end surface 22 of the head part 20, which results in expansion of the diameter of the flexible portion 44 in the radial direction. Preferably, the flexible material of the flexible portion 44 increases in diameter by about 1-3 mm in the radial direction RD when a force of approximately 250 N is applied to the first end 68. Preferably, the diameter of the flexible portion (44, 144) increases from 2 to 15% when a force of 250 N is applied to the flexible portion (44, 144), in particular with the force being applied to the flexible portion in a direction that is at least approximately parallel to the dispensing direction DD. In one embodiment, the flexible portion 44 increases in diameter about 2 mm in the radial direction RD. This radial expansion compresses the cartridge wall 18a of the compressed cartridge between a radial outer surface 74 of the flexible portion 44 and the inner surface 40 of the support sleeve 12a, and/or the inner surface 58 the skirt 54. This structure reduces residual waste or air entrapment in the cartridge.

The first end 68 of the flexible portion 44 can have any suitable configuration. For example, the first end 68 can be generally or substantially flat or planar, it can also have an acute or curved configuration or it can have a peaked or angled configuration. The radial outer surface 74 of the flexible portion 44 can be generally parallel to the longitudinal axis L of the piston 16a or in can form an angle with the longitudinal axis L. That is, the diameter D₄ of the flexible portion 44 at the radial outer surface 74 can decrease in the dispensing direction. That is the diameter D₄ of the flexible portion 44 can decrease in the dispensing direction DD. Preferably the height H₁ of the flexible portion 44 (from the point where the skirt meets the radial outer surface 73 of the rigid member) is between about 12 and 15 mm, and preferably about 14.2 mm. Moreover, the thickness T₁ of the flexible portion from the radial outer surface 73 of the first rigid portion 42a (i.e., the radial inner surface of the flexible portion 44) to the radial outer surface 74 of the flexible portion 44 is about 1.9 mm to about 5.2 mm, and preferably about 3.8 mm. The thickness T₂ of the flexible portion 44 from the protrusion 52 of the second rigid portion 42a to the first end 58 of the flexible portion 44 is between about 6.3 mm and 3.2 mm. The thickness T₁ of the flexible portion 44 from the first end 46 of the rigid portion 42 to the first end 68 of the flexible portion 44 is between about 6.5 mm and 8.3 mm. Thus, the ratio of a height H₁ of the flexible portion 44 to the distance from the first end 46 of the rigid portion 42 to the first end 68 of the flexible portion 44 is between about 0.5 to 0.55.

The height H₂ of the flexible portion 44 from the end 64 of the skirt 54 to the first end 68 of the flexible portion is about 7-9 mm. However, it is noted that the dimensions are merely examples and the dimensions of the flexible portion 44 relative to the rigid portion 42, and any other dimension can be any suitable dimension.

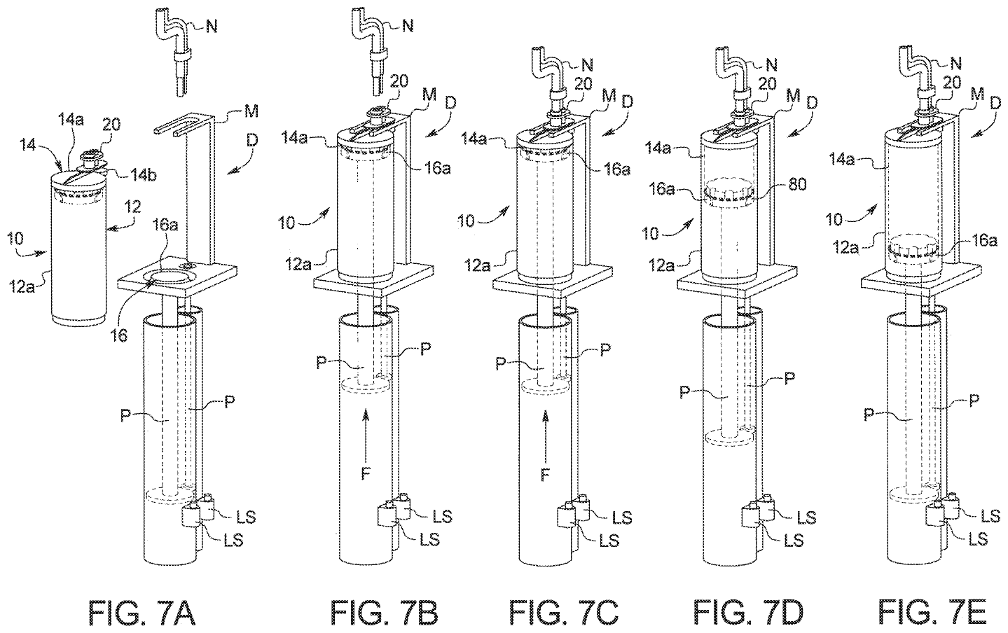

Turning to FIGS. 7A-7E, the manner in which the two-component collapsible cartridge 14 can be filled is illustrated. In one embodiment, the two-component collapsible cartridge 14 is shipped to the distributor or user in an empty state. As shown in FIGS. 7A, the empty two-component collapsible cartridge 14 is connected to the support cartridge system 12, and then as shown in FIG. 7B, inserted into a filling device D. The filling device D includes a mounting mechanism M that is configured to attach to the head part 20 to hold the two-component collapsible cartridge 14 in a desired and proper position. Once in position, the piston system 16 is inserted into the support cartridge system 12. A shown in FIG. 7B, the piston system 16 is acted upon by force from a plurality of plungers P. The force F exerted by each plunger P can be any suitable amount (e.g., 250 N), and supplied in any manner desired, for example using compressed air, a mechanical force or any other suitable device. The piston system 16 moves in the dispensing direction toward the end surface of the head part 20. As the piston system 16 moves in this direction, each piston 16a in the piston system 16 enters the open end 80 of a respective cartridge wall 18a and 18b. The edge 82 of each of the cartridge wall 18a and 18b is collected in the area between the skirt 54 and the outer radial surface 74 of the flexible portion 44. The heights H₁ and H₂ can be important here, since such heights can affect the amount air or component that is dispensed or expelled from the reception chambers 14a and 14b. As the piston system 16 continues to move and collect the cartridge walls 18a and 18b air is expelled from the cartridges.

The piston system 16 continues to move in the dispensing direction DD and contacts the end surfaces 22 and 24 of the head part 20. As the piston system 16 contacts these surfaces 22 and 24, the force F is maintained in the dispensing direction DD, thereby causing the flexible portion 44 of each of the pistons 16a and 16b to be compressed in the longitudinal direction L against the surfaces 22 and 24 of the head part 20. This compression causes the flexible portion 44 of each piston to radial expand in the radial direction. As described herein the radial expansion can be about 1-3 mm (or more preferably about 2 mm) when a force of approximately 250 N is applied to the first end 68; however, it is noted that the radial expansion can be any suitable amount. As shown in FIG. 8, the radial expansion occurs in the area in which the cartridge wall 18a has been gathered, thus compressing the cartridge wall 18a between the radial outer surface 74 of the flexible portion 44 and the inner surface 40 of the support sleeve 16a, and/or the inner surface 58 of the skirt 54. This compression expels additional air from the collapsed cartridge.

As shown in FIG. 7C, the filing nozzle N is then attached to the head part 20 and the desired components can be injected or dispensed into the cartridge walls 18a and 18b. The force F of the filling nozzle N expands the cartridge walls 18a and 18b and pushes the piston system 16 in the filling direction FD (opposite the dispensing direction), as shown in FIG. 7D. As is understood, the force F of the plungers P can be removed, such that the filling nozzle N is only required to overcome the static force of the plungers P and expansion of the cartridge walls 18a and 18b. Once the plungers P contact the limit switches LS the filling nozzle N can be stopped. The dispensing system 10 can then be removed and closed.

To dispense, the two-component collapsible cartridge 14 is simply inserted into the dispensing device and dispensed. If desired, the dispensing can be performed using the piston system 16 described herein, which would gather the cartridge walls 18a and 18b in the area between the skirts 54a and the radial outer surfaces 74 and dispense the components in a similar manner to the filing described above. That is, as the piston system 16 continues to move through the support cartridge system 12, the collapsible cartridge walls 18a and 18b are collected, and the components are dispensed through the head part 20. The piston system 16 then continues to move in the dispensing direction DD and contacts the end surfaces 22 and 24 of the head part 20. As the piston system 16 contacts these surfaces, the force F (e.g., 250 N) is maintained in the dispensing direction DD, thereby causing the flexible portion 44 of each piston 16a and 16b to be compressed in the longitudinal direction L against the surfaces 22 and 24 of the head part 20. This compression causes the flexible portion 44 of each piston 16a and 16b to radial expand. As described herein the radial expansion can be about 1-3 mm (or more preferably about 2 mm) when a force of approximately 250 N is applied to the first end 68; however, it is noted that the radial expansion can be any suitable amount. The radial expansion occurs in the area in which the cartridge walls 18a and 18b have been gathered, thus compressing the cartridge walls 18a and 18b between the radial outer surface 74 of the flexible portion 44 and the inner surface 40 of the support sleeves 12a and 12b, and/or the inner surface 58 of the skirts 54. This compression expels additional component from the collapsed cartridge.

The piston structure described herein improves the amount of component that can be dispensed by both removing excess air during the filling procedure and expelling additional component during the dispensing procedure. Such a system reduces waste of components, thereby reducing cost and environmental impact.

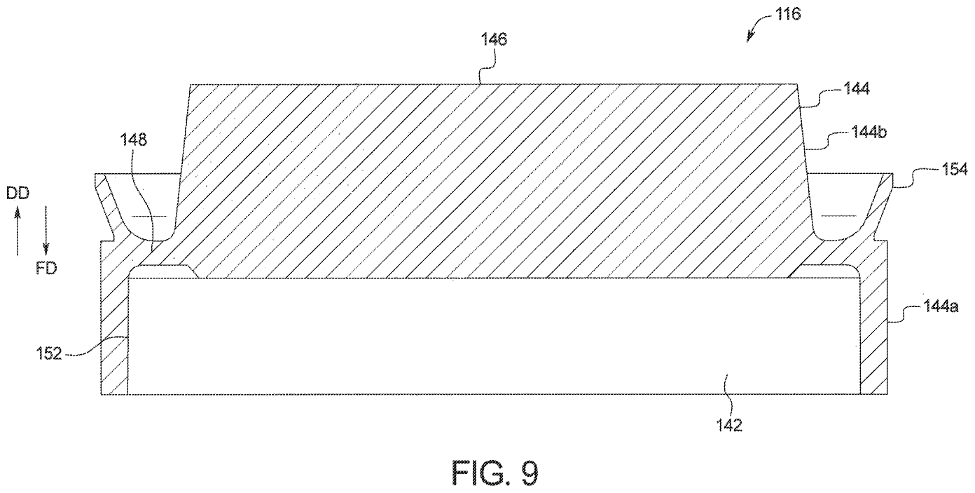

FIG. 9 is a partial cross-sectional view of a second embodiment or a piston 116. In this embodiment, the skirt 154 is attached to the flexible portion 144. That is, the flexible portion 144 includes a first portion 144a and second portion 144b. The first portion 144a is tubular and is connected to the rigid portion 142 at an outer radial 152 surface thereof. The second portion 144b generally comprises the compressible/flexible portion 146 that operates in the same manner as the flexible portion 144 described herein. The skirt 154, in this embodiment, is attached to a transverse portion 148 between the first and second portions 144a and 144b and extends in the dispensing direction DD. Here the second portion 144b preferably has a height between about 9.5 mm and 12.9 mm. The piston 116 operates in the same manner as described herein for the pistons 16a and 16b of the first embodiment.

Although the rigid portion 142 as shown in FIG. 9 has no protrusion 52 like the rigid portion 42 shown in FIGS. 5 and 6, one could also envisage that the rigid portion 142 may comprise a protrusion 52 similar to that of the rigid portion 42, with such a protrusion 52 being received in the cavity 71 of the flexible portion 144.

It is noted that any description of one piston described herein can be applied to multiple pistons.

The dispensing device, into which the present dispensing system is inserted to affect dispensing and the filling device are conventional components that are well known in the art. Since the dispensing device and the filling device are well known in the art, these structures will not be discussed or illustrated in detail herein. Rather, it will be apparent to those skilled in the art from this disclosure that the components can be any type of structure and/or include any programming that can be used to carry out the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” or “portion,” when used in the singular can have the dual meaning of a single part or a plurality of parts. Also as used herein to describe the above embodiment(s), the following directional terms refer to those directions of a system equipped with the piston for a collapsible cartridge. Accordingly, these terms, as utilized to describe the present invention should be interpreted relative to a system equipped with the piston for a collapsible cartridge.

The term “configured” as used herein to describe a component, section or part of a device includes hardware and/or software that is constructed and/or programmed to carry out the desired function.

The terms of degree such as “substantially”, “approximately” and “about” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A piston for a collapsible cartridge for dispensing a material, the piston comprising:
a rigid portion having a first diameter, a first end and a second end, the first end configured to be disposed in a material dispensing direction, the rigid portion further comprising a skirt extending from a radial outer surface of the rigid portion in the material dispensing direction; and
a flexible portion having a second diameter less than the first diameter, a first end disposed in the material dispensing direction and a second end disposed in an opposite direction, the first end of the flexible portion extending entirely beyond an end of the skirt in the material dispensing direction, and the flexible portion being disposed on the first end of the rigid portion such that the second end of the flexible portion is disposed to face the first end of the rigid portion, and the flexible portion configured to radially expand and longitudinally compress upon a force applied to the first end of the flexible portion so as to compress the collapsible cartridge between the flexible portion and an interior surface of a support cartridge.

2. A piston for a collapsible cartridge for dispensing a material, the piston comprising:
a rigid portion having a first diameter, a first end and a second end, the first end configured to be disposed in a material dispensing direction;
a flexible portion having a second diameter less than the first diameter, a first end disposed in the material dispensing direction and a second end disposed in an opposite direction, the flexible portion being disposed on the first end of the rigid portion such that the second end of the flexible portion is disposed to face the first end of the rigid portion, and the flexible portion configured to radially expand and longitudinally compress upon a force applied to the first end of the flexible portion so as to compress the collapsible cartridge between the flexible portion and an interior surface of a support cartridge; and
a skirt configured to gather the cartridge as the cartridge is compressed, the skirt is disposed on one of the flexible portion and the rigid portion and including a longitudinally extending tab on an outer surface.

3. The piston according to claim 1, further comprising
a skirt configured to gather the cartridge as the cartridge is compressed.

4. The piston according to claim 3, wherein
the skirt is disposed on one of the flexible portion and the rigid portion.

5. The piston according to claim 3, wherein
the skirt includes a tab on an outer surface.

6. The piston according to claim 2, wherein
at least one hole is disposed in the skirt.

7. The piston according to claim 1, wherein
the first end of the flexible portion is planar, curved, peaked or angled.

8. The piston according to claim 1, wherein
the flexible portion includes a radial outer surface, the radial outer surface having the second diameter that decreases in the material dispensing direction.

9. The piston according to claim 1, wherein
the flexible portion is formed from a material having a durometer between about 15 and 60.

10. The piston according to claim 1, wherein
the flexible portion is formed from at least one of a flexible material, an elastomeric material, a thermoplastic elastomer or silicone.

11. The piston according to claim 9, wherein
a diameter of the flexible material is configured to radially expand between about 1 mm and 3 mm when the force is approximately 250 N.

12. The piston according to claim 1, wherein
a diameter of the flexible portion increases from 2 to 15% when the force applied to the flexible portion is 250 N.

13. The piston according to claim 1, wherein
the flexible portion includes an internal cavity and at least a portion of the rigid portion extends into the internal cavity.

14. The piston according to claim 1, wherein
the first end of the rigid portion includes a protrusion at the circumferential edge thereof.

15. The piston according to claim 14, wherein
a cavity of the flexible portion forms a recess that receives the protrusion of the rigid portion.

16. The piston according to claim 1, wherein
the flexible portion includes an internal cavity and at least a portion of the rigid portion extends into the internal cavity, such that the ratio of a height of the flexible portion to the distance from the first end of the rigid portion to the first end of the flexible portion is between about 0.5 to 0.55.

17. A dispensing system, comprising:
a cartridge having a head part and a cartridge wall which define a reception chamber configured to retain a medium to be dispensed, the head part including a surface and an outlet in the surface, the outlet configured to enable the material to be dispensed therethrough, the cartridge wall configured to be collapsible; and
the piston according to claim 1 configured to collapse the cartridge and dispense the medium, the flexible portion configured to radially expand upon the force being applied to the piston in the material dispensing direction such that the first end of the flexible portion contacts the surface of the head part.

18. A dispensing system, comprising:
a cartridge having a head part and a cartridge wall which define a reception chamber configured to retain a medium to be dispensed, the head part including a surface and an outlet in the surface, the outlet configured to enable the material to be dispensed therethrough, the cartridge wall configured to be collapsible; and
the piston according to claim 1 configured to collapse the cartridge and dispense the medium, the flexible portion configured to radially expand between about 1 mm and 3 mm upon the force being applied to the piston in the material dispensing direction such that the first end of the flexible portion contacts the surface of the head part.

19. The dispensing system according to claim 17, wherein
the second diameter of the flexible portion decreases in the material dispensing direction.

20. The dispensing system according to claim 17, wherein
the flexible portion is formed from a material having a durometer between about 15 and 60, such that the flexible material is configured to radially expand between 1 mm and 3 mm upon the contact with the surface of the head part when the force is approximately 250 N.

21. A method of filling a material into a cartridge, the method comprising:
collapsing the cartridge with a piston according to one of the previous claims, the piston having a rigid portion and a flexible portion, the flexible portion being disposed at the dispensing end of the piston;
applying a force to the piston such that the flexible portion of the piston contacts a surface of a head part of the cartridge, causing a diameter of the flexible portion to radially increase;
compressing the cartridge between a radial surface of the flexible portion and an interior surface of a cartridge support; and
adding the material through an opening in the head part, causing the piston to move in a direction away from the head part.

22. The method of claim 21, wherein
the collapsing the cartridge includes gathering the cartridge in a skirt disposed on the piston.

23. The method of claim 21, wherein
the applying the force to the piston includes applying a force of approximately 250 N, causing the diameter of the flexible portion to increase between about 1 mm to 3 mm to expel air from the cartridge.

24. A method of dispensing a material from a cartridge comprising:
providing the dispensing system according to claim 17, and
applying a second force to the piston to dispense the material through the opening in the head part.

25. The method of claim 24, wherein
the applying the second force to the piston causes the cartridge to be gathered in a skirt disposed on the piston.

26. The method of claim 24, wherein
the applying the second force to the piston causes the flexible portion to contact the surface of the head part and the diameter of the flexible portion to radially increase and a radial circumferentially surface of the flexible portion to contact a portion of the cartridge to dispense the material through the opening in the head part.
